(19) United States
(12) Patent Application Publication
(10) Pub. No.: US 2014/0307431 A1
(43) Pub. Date: Oct. 16, 2014

(54) Field Configurable Industrial LED Light Fixture

(71) Applicant: Xeralux, Inc., Sunnyvale, CA (US)

(72) Inventors: Victor Santashev, Maple (CA); Chris W. Barnard, Sunnyvale, CA (US)

(21) Appl. No.: 13/863,938

(22) Filed: Apr. 16, 2013

(51) Int. Cl. F21K 99/00; F21V 29/00

(52) U.S. Cl. CPC F21K 9/30; F21K 9/50; F21V 29/004
USPC 362/235; 362/249.02

(57) ABSTRACT

A field configurable industrial light fixture is disclosed that includes a power module unit to which an arbitrary number of petals containing LEDs can be coupled. The fixture enables configuration of the amount and orientation of the light emitted from the solid-state lighting devices to be adapted in the field to suit the particular application of the fixture.

### BACKGROUND OF THE INVENTION

This invention relates to solid-state lighting, and in particular to an industrial LED light fixture that may be configured in the field to meet desired lighting needs for particular locations and applications.

Numerous types of fixtures are now a well known for use with light emitting diodes (LEDs). Such fixtures, however, generally have been of the type that does not permit adjustment of the orientation or amount of light provided by the fixture. In many applications, however, it is desirable to be able to provide light in varying amounts at varying locations within the facility. For example, more light may be required portions of the facility where fine manufacturing operations are carried out, as opposed to in offices, where users of the offices may have lamps on their desks.

In general, and in previous approaches to this need, different types and sizes of fixtures were installed at different locations in the factory, office building, or other location. This has the disadvantage of requiring removing and replacing the lighting fixtures when different tasks are moved to different locations. Of course each different fixture may require its own different type of installation, its own special attachment to the building, and other customization. In addition, the varying fixture types require inventorying each type of fixture in appropriate numbers, training installers to install each type, and various other fixture specific aspects. With these varying types of fixtures comes increased costs, increased maintenance, and additional time required for installation, modification, or repair. These disadvantages can become even more problematical when existing incandescent or florescent fixtures are to be replaced by fixtures that use light emitting diodes (LEDs).

What is needed is a lighting fixture for solid-state lighting, such as LEDs, which may be adapted in the field to the needs of each particular facility and location within that facility, but which is otherwise “universal.”

### SUMMARY OF THE INVENTION

The field configurable industrial light fixture described here includes a base unit (or puck) to which multiple LED lighting units (or petals) can be coupled. The fixture enables configuration of the amount and orientation of the light emitted from the solid-state lighting devices on each petal to be arbitrarily modified in the field to suit the particular application of the fixture.

In a preferred embodiment a lighting fixture for solid-state light emitting devices includes a base unit to which electrical power can be supplied. The base unit includes a lower portion having an outer perimeter; and a series of fittings arranged around the outer perimeter, each fitting being adapted to mechanically support a petal coupled to that fitting. Each of the individual petals includes a mechanical connector configured to be physically supported by one of the series of fittings arranged around the outer perimeter of the base, a heat sink, and an array of solid state light emitting devices affixed to the heat sink. A desired number of petals may be affixed to the base in arbitrary orientations around the base.

Preferably the solid-state light emitting devices comprise light emitting diodes (LEDs) with a lens over them to diffuse the emitted light. Each of the fittings includes a slot having an open end and a closed end, and each of the petals includes a protruding portion that slides into the slot and is retained in position by the closed end of the slot.

### BRIEF DESCRIPTION OF THE DRAWINGS

FIG. 1 illustrates a field configurable industrial led light fixture;

FIG. 2 illustrates a field configurable industrial LED light fixture with an extension unit; and

FIG. 3 is a more detailed view of the mechanical and electrical connections between the base unit and the lighting units.

### DETAILED DESCRIPTION OF THE PREFERRED EMBODIMENTS

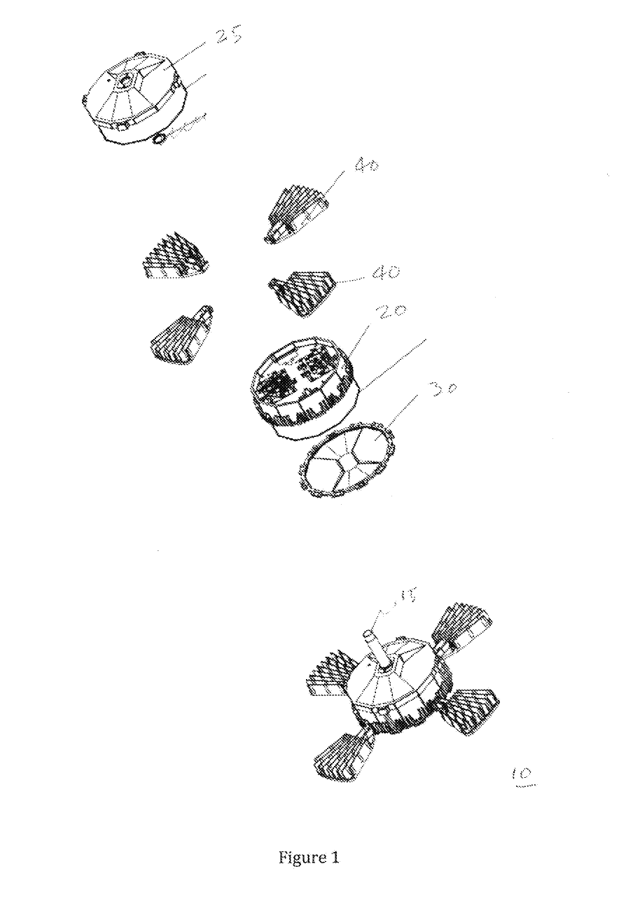

FIG. 1 is a perspective view of a field configurable solid-state lighting fixture 10 illustrating its principal components and assembly. The assembled field configurable solid-state lighting fixture 10 is shown at the bottom of FIG. 1. The manner in which the components are combined to make the fixture is illustrated in the remaining portion of FIG. 1.

The particular implementation in FIG. 1 includes a power module 20, a top cover 25, a bottom cover 30, and four petals 40. A post 15 is used to connect the unit 10 to an appropriate fitting in the facility to which it is to be installed. The post 15 will usually be connected to an electrical box in the ceiling of the facility where the fixture 10 is to be mounted. Typically, conventional AC electric power will be provided in the ceiling of the facility, and the appropriate electrical cabling extends down through the post 15 into the power module 20. The power module will usually include an Ac to DC converter unit, and one or more controller boards upon which LED control electronics has been mounted.

The power module 20 includes connections to distribute that necessary electrical power to the individual light petals 40 of the fixture 10. We refer to the architecture illustrated in FIG. 1 as “petal-puck” architecture because the base unit 10 resembles a “puck,” and as many “petals” as desired may be affixed to it. In the illustration of FIG. 1 four petals 40 are shown, however, as many as desired may be affixed to the “puck” depending upon its size. As will be described in more detail below, each petal 40 includes an array of light emitting diodes mounted to the lower surface of the petal, over which a lens is usually placed.

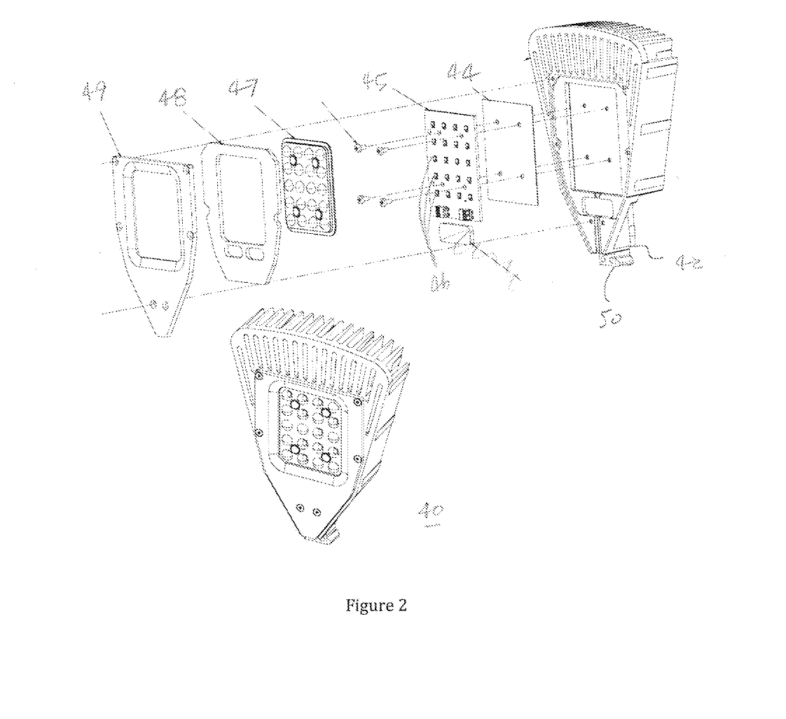

FIG. 2 is a perspective view of one petal 40 of a field configurable solid-state lighting fixture 10 illustrating the principal components and assembly of petal 40. The components illustrated there include the metal substructure 42 which also functions as a heat sink, a sheet of thermally conductive material 44 which couples circuit board 45 to the heat sink 42 enabling heat from the LEDs 46 to be dissipated by the heat sink 42. Over the LEDs 46, a lens array 47 is positioned. The lens array can be any lens array of appropriate form factor. Its particular configuration will depend upon the particular application for the fixture 10. For example, in some installations it will be desired to diffuse the light from the LEDs more than in others, and a suitable lens array can be designed to implement that. A sheet 44 of thermally conductive material 44 helps assure that heat generated by the LEDs 46 on printed circuit board 45, is dissipated by heat sink 42. The lens array 47 is secured to the circuit board by a gasket 48 and a lens clamp frame 49.

The power module 20 includes cooling fins to help dissipate heat generated by the electrical components within the unit. In addition, each petal 40 includes similar cooling fins to help dissipate the heat from the array of LEDs on each petal. In a preferred embodiment each of the petals is identical to the others, although for unique requirements, different styles of petal may be used.

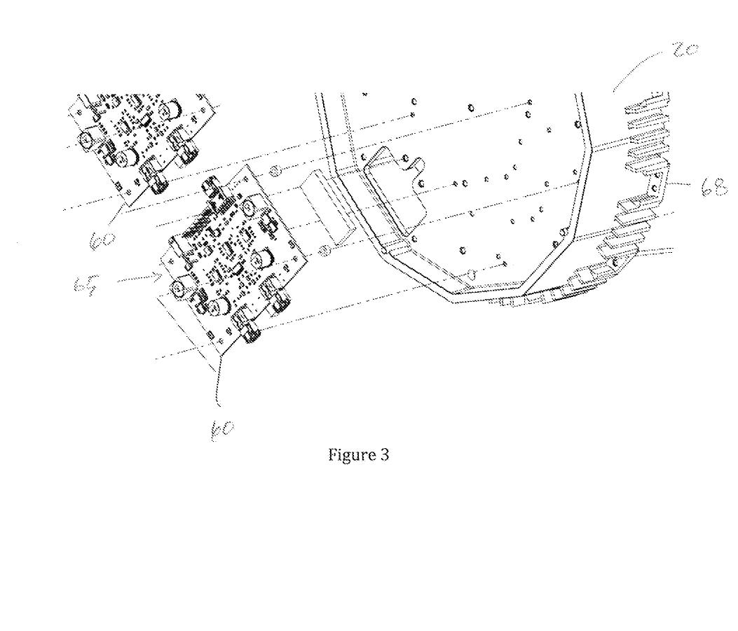

FIG. 3 illustrates the power module 20 in more detail. LED controller printed circuit boards 60 and associated circuitry 65 mounted thereon are secured to the power module, and protected from ambient conditions by the top cover 25 (see FIG. 1). The cover can be fastened to the power module using fasteners such as bolts and sealed with an O-ring. The petals 40 connect to the exterior of the power module 20 via a protruding engagement portion 50 (see FIG. 2) on the end of each petal 40. These portions 50 engage with corresponding slots 68 (see FIG. 3) on the lower portion of the outer perimeter of the exterior of the power module 20. As shown by the illustration, the petals 40 fit into the slots 68 in the upper portion of the perimeter, and then are locked in place when moved to the lower portion of each slot. The closed end at the lower end of the slot 68 prevents the petals from slipping out of the power module 20. Electrical connections between the power module circuit boards 60 and the LEDs on each petal 40 is made through openings (not shown) between the base of the petal 40 and the power module 20.

As shown by FIGS. 1 and 3, the power module 20 can be of arbitrary size, and adapted to provide an arbitrary number of slots 68 for the petals. In the particular unit illustrated in FIG. 1, four petals 40 are shown. As shown in more detail by FIG. 3, between each two adjacent petals, additional empty slots are provided for additional petals 40 if more light is desired. The power module unit 20 of FIG. 1 thus can accommodate any number of petals from 1 to 12. Of course, should more pedals be desired, a larger power unit can be provided, or multiple power units can be stacked one atop the other between the top and bottom covers.

An advantage of the structure described here is that the petals 40 do not need to be arranged symmetrically on the power module 20. For example, if the power module 20 is near a wall, all of the petals can be inserted into the base unit on the opposite side of the base unit from the wall, or fewer petals can be used. One benefit of the structure illustrated is that by installing an array of connecting posts 15 and power modules 20 throughout a facility, appropriate numbers of petals arranged in any desired orientation can be used on different fixtures in different locations throughout a facility. In this manner more light can be provided in some locations than others without need for use of customized fixtures in different locations.

All of these capabilities are made possible by the “universal” nature of the power module 20 and petals 40. For example, if more light is desired on one side of unit 10 than another side, the petals can be arranged to meet that need. If more light is desired in one location than was originally provided, it is a relatively simple matter to add additional petals 40 to the fixture 10 at a later date. Once a technician is appropriately trained in installation, the same installation techniques can be used throughout a facility without the necessity of training the technician in the installation of different types of fixtures.

In the preferred embodiment the power module 20 is coupled to conventional AC power, and the LED controller circuit boards 60 provide appropriate voltages and current to the LEDs on the individual petals. The electrical connections between each petal and the base unit is preferably made by wiring extending through an opening in the exterior surface of the power module to enable wires to connect between the interior of the base unit and the petals. Alternatively, each slot 68 can include a socket to which the petal “automatically” when it is inserted into the slot.

We claim:

1. A lighting fixture for solid-state light emitting devices comprising:
a power module unit to which electrical power can be supplied, the power module unit including:
at least one controller circuit board for the solid-state light emitting devices;
a lower portion having an outer perimeter; and
a plurality of fittings arranged around the outer perimeter, each fitting being adapted to mechanically support a petal coupled to that fitting;
at least one petal coupled to the power module unit, the petal including:
a mechanical connector configured to be physically supported by one of the plurality of fittings arranged around the outer perimeter of the base;
a heat sink; and
a plurality of solid-state light emitting devices affixed to the heat sink; and
whereby a desired number of petals may be affixed to the base in varying orientations around the base.

2. A lighting fixture as in claim 1 wherein the solid-state light emitting devices comprise an array of light emitting diodes (LEDs).

3. A lighting fixture as in claim 2 further comprising a lens array disposed over the array of LEDs.

4. A lighting fixture as in claim 2 wherein each of the petals further includes a plurality of fins affixed to a back side of the heat sink to help cool the heat sink.

5. A lighting fixture as in claim 1 wherein:
each of the plurality of fittings includes a slot having an open end and a closed end, and
each of the petals includes a protruding portion which slides into the slot and is retained in position by the closed end of the slot.

6. A lighting fixture as in claim 1 further comprising a transformer disposed within the power module unit, and wherein AC power supplied to the power module unit is converted to DC power before being provided to each of the petals.

7. A lighting fixture as in claim 1 further comprising a top cover and a bottom cover to protect the power module from ambient conditions.

8. A lighting fixture as in claim 1 wherein:
the lower portion of the power module further includes a plurality of polygonal sides, each one of the polygonal sides including one of the plurality of fittings; and
the mechanical connector on each petal engages with a corresponding one of the plurality of fittings.

9. A lighting fixture as in claim 8 wherein the plurality of polygonal sides comprises 12 sides, and the desired number of petals is 12.

10. A lighting fixture as in claim 1 wherein each petal has a first smaller width at the mechanical connector and a second larger width at an end opposite the mechanical connector.

11. A lighting fixture as in claim 1 wherein the plurality of solid-state light emitting devices are mounted on a circuit board which is affixed to the heat sink.

12. A lighting fixture as in claim 11 wherein the heat sink of each petal further comprises:
a first lower surface to which the circuit board is affixed; and
a second upper surface from which a plurality of fins extend to help cool the heat sink.

13. A lighting fixture as in claim 12 wherein:
the plurality of solid-state light emitting devices are arranged in an array on the circuit board; and
an array of lenses is disposed over the array of solid-state light emitting devices.

14. A lighting fixture as in claim 13 wherein the array of lenses is held in position with regard to the array of solid-state light emitting devices by a lens clamp frame.
